(19) United States
(12) Patent Application Publication
(10) Pub. No.: US 2004/0193501 A1
(43) Pub. Date: Sep. 30, 2004

(54) Multiprice commerce service

(75) Inventor: Lee Allen, San Jose, CA (US)

Correspondence Address: Tadashi Horie, Brinks Hofer Gilson & Lione, NBC Tower, Suite 3600, P.O. Box 10395, Chicago, IL, 60610, US

(73) Assignee: DoCoMo Communications Laboratories USA, Inc.

(21) Appl. No.: 10/397,087

(22) Filed: Mar. 26, 2003

(51) Int. Cl. G06F 17/60

(52) U.S. Cl. 705/26

(57) ABSTRACT

The Multiprice Commerce Service includes a method of procuring transactions between a vendor and customers of a Hyper Operator. The Hyper Operator constructs a real-time varying sellers' function which is a representation of the willingness of the vendor to sell a product as a function of price. The customers detect a sell offer for the product and each transmits a maximum price that she is willing to pay. The Hyper Operator aggregates the buy offers, constructs a real-time varying buyers' function which continuously compares the buyers' function to the sellers' function and when a comparison yields a profit level that at least meets a predetermined target level specified by the vendor, consummates a sale of the product between a qualifying customer and the vendor, all sales of the product to different buyers being conducted by the Hyper Operator in a single aggregate transaction.

### BACKGROUND

1. This application relates to a multiprice commerce service. More specifically, this application relates to a multiprice commerce service in which sellers and purchasers functions of a product or service are aggregated and vary in real time, these functions are compared, and customer-specific and real-time contextual information is used to personalize notification to the purchaser and seller once a sale is consummated.

2. Background Information

With the advent of wireless communication devices, such as cellular telephones or PDAs, access to the internet is now increasingly mobile. Mobile wireless customers have traditionally been connected to only one network operator, with both basic services such as voice communications and enhanced services such as Internet access provided by that network operator.

In the future, however, Hyper Operators, which are carriers that may or may not own their own infrastructure, will make a wider variety of services available to their customers, essentially being a proxy acting on the behalf of its customers. These services will be provided by a many different third parties, including many different infrastructure operators in a heterogeneous access environment. This heterogeneous access environment includes the different operators as well as multiple users of different types of devices, each of which may use a different communication format. Despite the various environments and services that will be present, the customer will contract with the Hyper Operator and will expect all dealings to be with the Hyper Operator, regardless of how many operators, vendors and other providers are involved in the provision of services. This is true no matter what type of communication system is being used: mobile or not, wireless or wired.

Presently, transactions via various communication systems such as internet transactions use relatively static models of publish-response in which individual vendors of products post prices for these products and individual buyers accept the posted offers. In other words, one price is established for the entire market until the vendor changes the price, or individual buyers post the prices they are willing to pay and individual sellers accept the offers, again one price is established for the entire market as an individual sale of one specific item at a time. Similarly, interactive auctions through the internet, for example, use static publish-response models in which buyers continually attempt to outbid other buyers for the products/services that sellers have offered for sale, up until a particular time or monetary value for the product has been reached.

However, such static systems create problems for both parties. Examples of these problems include that neither the buyer nor seller knows whether they are getting the optimal price, whether there are any other buyers (for the seller) or sellers (for the buyer) willing to meet their particular demand, and the relatively inordinate length of time it takes before a mutually agreeable price is obtained or an auction ends.

Thus, a demand exists for communications technologies which will allow both buyers and sellers to have a more dynamic model in which sets of buyers and sellers, rather than individual buyers and sellers, converge on an optimal deal promptly for each individual buyer and seller. Further, although Hyper Operators currently play little or no role in auctions, they have the potential to benefit both potential buyers and sellers in such an auction by either controlling these auctions or making the transactions mostly opaque to both the customer of the Hyper Operator and vendor.

### BRIEF SUMMARY

To achieve the above objectives and obtain the advantages disclosed herein, means of improving transactions between consumers and vendors in multiple communication systems are disclosed.

In one embodiment of a method of procuring transactions between at least one vendor and customers of a Hyper Operator that provides service to communication devices (mobile, non-mobile, wireless, or wired) possessed by the customers comprises: the Hyper Operator constructing a sellers' function which varies in real time and is a representation of the willingness of the vendor to sell a product offered by the vendor as a function of price; the customers detecting, on the device, a sell offer for the product, each customer then entering only a maximum price for the product into the device and transmitting the maximum price to the Hyper Operator prior to consummation of any sale to that customer to thereby signify a buy offer to the Hyper Operator; the Hyper Operator receiving and subsequently aggregating the buy offers, constructing a buyers' function which varies in real time, continuously comparing the buyers' function to the sellers' function, and, when a comparison yields a profit level that at least meets a predetermined target level specified by the vendor, consummating a sale of the product between a qualifying customer and the vendor, all sales of the product to different customers being conducted by the Hyper Operator in a single aggregate transaction; and the Hyper Operator notifying the qualifying customer and vendor of the sale, notification of the customer being personalized through use of customer-specific and real-time contextual information.

This method may further comprise the Hyper Operator constructing the sellers' function as a representation of the willingness of different vendors to sell the product as a function of price and, when the comparison yields a profit level that at least meets a predetermined target level specified by a particular vendor, consummating a sale of the product between a qualifying customer and the particular vendor.

Alternatively, the method may further comprise limiting sales to customers who are only buyers of consumer products or submitting customer information to the vendor only after consummation of the sale.

In another embodiment, the method comprises: the Hyper Operator constructing a sellers' function which varies in real time and is a representation of the willingness of the vendor to sell a product offered by the vendor as a function of price; the customers detecting, on the device, a sell offer for the product, each customer then entering only a maximum price for the product into the device prior to consummation of any sale to that customer; and the Hyper Operator receiving a buy offer from each customer and subsequently aggregating the buy offers, constructing a buyers' function which varies in real time, continuously comparing the buyers' function to the sellers' function, and, when a comparison of a particular maximum price by a particular customer yields a profit level that at least meets a predetermined target level specified by the vendor, consummating a sale of the product between the particular customer and the vendor at the particular maximum price, the sales being consummated starting with a highest maximum price bid by the customers and continuing until one of some criterion set by the vendor is reached and no customers remain with whom to consummate a sale, all sales of the product to different buyers being conducted in a single aggregate transaction.

This method may further comprise each customer separately signifying the buy offer to the Hyper Operator after entering the maximum price for the product into the device, the vendor setting the criterion as a maximum amount of product to be sold, the Hyper Operator notifying the particular customer and vendor of the sale, notification of the customer being personalized through use of customer-specific and real-time contextual information, limiting sales to customers who are only buyers of consumer products, submitting customer information to the vendor only after consummation of the sale, the Hyper Operator constructing the sellers' function as a representation of the willingness of different vendors to sell the product as a function of price and, when the comparison of the particular maximum price by the particular customer yields the profit level that at least meets the predetermined target level specified by a particular vendor, consummating the sale of the product between the particular customer and the particular vendor at the particular maximum price, the sales being consummated starting with the highest maximum price bid by the customers and continuing until some criterion set by the particular vendor is reached, all sales of the product to different buyers being conducted in a single aggregate transaction simultaneously, or selling to the customers at at least two different prices.

In another embodiment, the method comprises: customers purchasing a product of the vendor through the Hyper Operator at prices agreeable to each individual customer; the vendor maximizing profits from sales to the customers by selling the product to customers who are willing to pay the most first and selling the product to customers who are willing to pay increasingly smaller amounts successively until some criterion set by the vendor is reached; and the Hyper Operator conducting all sales of the product to different buyers in a single aggregate transaction and notifying purchasing customers and the vendor of the sale with notification of the purchasing customers being personalized through use of customer-specific and real-time contextual information.

This method may further comprise selling to the customers at a maximum acceptable price for each customer, selling to the customers at at least two different prices, the vendor setting the criterion as one of a maximum amount of product to be sold and a minimum profit for each product, the vendor compensating the Hyper Operator with a contract fee, a per-offer fee, and a per-purchase-transaction fee, a plurality of vendors supplying the product, each vendor maximizing profits from sales to the customers by selling the product to customers who are willing to pay the most first and selling the product to customers who are willing to pay increasingly smaller amounts successively until a criterion set by the vendor is reached, the customers establishing with the Hyper Operator a particular product desired and the Hyper Operator indicating when the sellers have that particular product for sale, each customer entering only a maximum price for the product into the device prior to consummation of any sale to that customer (and perhaps each customer separately signifying the buy offer to the Hyper Operator after entering the maximum price), limiting sales to customers who are only buyers of consumer products, or submitting customer information to the vendor only after consummation of the sale.

In another embodiment, the method comprises: the Hyper Operator constructing a sellers' function which varies in real time and is a representation of the willingness of each vendor to sell a product offered by the vendors as a function of price; the customers detecting, on the device, a sell offer for the product, each customer then entering only a maximum price for the product into the device prior to consummation of any sale to that customer; and the Hyper Operator receiving a buy offer from each customer and subsequently aggregating the buy offers, constructing a buyers' function which varies in real time, continuously comparing the buyers' function to the sellers' function, and, when a comparison of a particular maximum price by a particular customer yields a profit level that at least meets a predetermined target level specified by a particular vendor, consummating a sale of the product between the particular customer and the particular vendor at the particular maximum price, the sales being consummated starting with a highest maximum price bid by the customers and continuing until one of criteria set by the vendors are reached and no customers remain with whom to consummate a sale, all sales of the product to different customers being conducted in a single aggregate transaction.

This method may further comprise each customer separately signifying the buy offer to the Hyper Operator after entering the maximum price for the product into the device, the vendors setting the criterion as a maximum amount of product to be sold, the Hyper Operator notifying the particular customer and vendor of the sale, notification of the customer being personalized through use of customer-specific and real-time contextual information, limiting sales to customers who are only buyers of consumer products, submitting customer information of customers who purchase the product from the particular vendor to the particular vendor only after consummation of the sales, or selling to the customers at at least two different prices.

In another embodiment, a communication network that establishes transactions between at least one vendor and customers of a Hyper Operator, the Hyper Operator providing service to communication devices (mobile, non-mobile, wireless, or wired) possessed by the customers, comprises: a first computation mechanism to compute a sellers' function which varies in real time, is constructed by the Hyper Operator, and is a representation of the willingness of the vendor to sell a product offered by the vendor as a function of price; a second computation mechanism to compute a buyer's function which varies in real time and is constructed by the Hyper Operator, the buyer's function containing an aggregation of maximum prices that each of the customers is willing to pay for the product and have been transmitted to the Hyper Operator, the maximum price being the only information entered by each customer prior to consummation of any sale to that customer; a comparison mechanism that continuously compares the buyers' function to the sellers' function; a transaction mechanism that, when a comparison yields a profit level that at least meets a predetermined target level specified by the vendor, consummates a sale of the product between a qualifying customer and the vendor; and a notification mechanism that notifies the qualifying customer and vendor of the sale as well as personalizes the notification to the qualifying customer through use of customer-specific and real-time contextual information, wherein all sales of the product to different customers are conducted by the Hyper Operator in a single aggregate transaction.

In another embodiment, a computer readable storage medium storing computer readable program code for providing transactions between at least one vendor and customers of a Hyper Operator that supplies service to communication devices possessed by the customers, comprises a computer code that implements: construction of a sellers' function which varies in real time and is a representation of the willingness of the vendor to sell a product offered by the vendor as a function of price; detection and aggregation of an offer for the product entered by each customer into the device, each offer containing only a maximum price willing to be paid by the customer; construction of a buyers' function which varies in real time from the aggregation of maximum prices; continuous comparison of the buyers' function to the sellers' function, and, when a comparison of a particular maximum price by a particular customer yields a profit level that at least meets a predetermined target level specified by the vendor, consummation of a sale of the product between the particular customer and the vendor at the particular maximum price; and notification of the particular customer and vendor of the sale and personalization of the notification to the particular customer through use of customer-specific and real-time contextual information, wherein all sales of the product to different buyers are conducted in a single aggregate transaction.

The computer readable program code may further comprises computer code that: consummates sales starting with a highest maximum price bid by the customers and continuing until one of some criterion set by the vendor is reached and no customers remain with whom to consummate a sale (and additionally sets the criterion as one of a maximum amount of product to be sold and a minimum profit for each product perhaps), transfers a debit to the vendor and a credit to the Hyper Operator for one of a per-offer fee for each offer and a per-purchase-transaction fee for each sale, maximizes profits for the vendor from sales to the customers by consummating sales of the product to customers who are willing to pay the most first and consummating sales of the product to customers who are willing to pay increasingly smaller amounts successively until a criterion set by the vendor is reached, constructs the sellers' function as a representation of the willingness of each vendor of a plurality of vendors offering the product as a function of price (and perhaps maximizes profits for each vendor from sales to the customers by consummating sales of the product to customers who are willing to pay the most first and consummating sales of the product to customers who are willing to pay increasingly smaller amounts successively until a criterion set by each vendor is reached), enables each customer to separately signify the offer after entering the maximum price for the product into the device but before aggregation of the offer, limits sales to customers who are only buyers of consumer products, or submits customer information of the particular customer to the vendor only after consummation of the sale.

In another embodiment, an electronic unit houses a Hyper Operator that procures transactions between vendors and customers of the Hyper Operator which provides services for a communication device possessed by the customers. The electronic unit comprises a transmitter/receiver through which the electronic unit communicates with external sources including vendors and the customers. The transmitter/receiver is configured to transmit a sell offer for a product offered by at least one of the vendors to the customers and to receive a buy offer from each of the customers requesting the product. Each buy offer contains a maximum price for the product willing to be paid by the customer who has entered that maximum price as a buy offer (other information, such as the customer's identity is added by the terminal the customer is using, but the customer may only have to enter the maximum price). A processor is configured to construct a sellers' function which varies in real time and is a representation of the willingness of the at least one of the vendors to sell the product as a function of price, aggregate the buy offers and construct a buyers' function which varies in real time, continuously compare the buyers' function to the sellers' function, and, when a comparison yields a profit level that at least meets a predetermined target level specified by the at least one of the vendors, consummates a sale of the product between a qualifying customer and the at least one of the vendors, in which all sales of the product to different customers are conducted in a single aggregate transaction. A memory is configured to amass a customer database of customer-specific and real-time contextual information of the customers. The transmitter/receiver is configured to transmit notification to the qualifying customer and the at least one of the vendors of the sale in which the notification to the customer is personalized by the processor through the customer-specific and real-time contextual information. An interface is used through which internal elements of the electronic unit communicate.

The processor may be configured to construct the sellers' function as a representation of the willingness of different vendors to sell the product as a function of price and, when the comparison yields a profit level that at least meets a predetermined target level specified by a particular vendor, consummate a sale of the product between the qualifying customer and the particular vendor. The processor may be configured to submit customer information to the vendor only after consummation of the sale. The processor may be configured to consummate the sales starting with a highest maximum price bid by the customers and continue until one of: some criterion set by the vendor is reached and no customers remain with whom to consummate a sale and be further configured to conduct all sales of the product to different buyers in a single aggregate transaction. The criterion may be a maximum amount of the product to be sold and/or a minimum price of the product to be sold. The processor may be configured to limit sales to customers who are only buyers of consumer products.

### BRIEF DESCRIPTION OF THE DRAWINGS

FIG. 1 shows a first step in a first embodiment;

00241 FIG. 2 shows a second step in the first embodiment;

FIG. 3 shows a third step in the first embodiment;

FIG. 4 shows a fourth step in the first embodiment;

FIG. 5 shows a fifth step in the first embodiment;

FIG. 6 shows a sixth step in the first embodiment;

FIG. 7 shows revenue flow according to the first embodiment.

### DETAILED DESCRIPTION OF THE DRAWINGS AND THE PRESENTLY PREFERRED EMBODIMENTS

The Multiprice Commerce Service is fundamentally different from other selling systems in that it time-compresses the demand curve for products, both increasing and providing immediate vendor profits as well as saving vendors significant expenditures and permitting sales of multiple products at the same time. Further, the products are provided at prices determined by each customer, and each customer is assured the best price (at the available prices) for himself or herself. No additional intermediary is needed in the Multiprice Commerce Service as it builds upon the Hyper Operator's role as the trusted advocate and proxy for the customer, while reflecting that both vendors and consumers are customers of the Hyper Operator. As used herein, however, only the consumers will be referred to as customers or buyers while the vendors will alternately be referred to as sellers. In addition, consumers as used herein are individual buyers of retail or wholesale goods and services only, while vendors are individual sellers of these retail or wholesale consumer goods and services.

Although herein from time-to-time reference will be made specifically to mobile or wireless communication networks, the Hyper Operators discussed may be associated with any type of communication network, mobile, fixed, wired, or wireless. Each Hyper Operator may be a single point of contact for the customer, and allows the Hyper Operator to offer services that are optimized to the customer's current context, which includes the mode of access and/or the type of network being used. Hyper Operators who service customers may provide, among others, Internet-based services that incorporate personal information about the customer such as age, job, and marital status. In addition, other information regarding preferences of the user, frequently visited Internet sites or recent purchases on various sites for example, may be incorporated into the service requested. Such a system can further streamline both the parameters and responses of services provided by using information based on the context of the customer. This is more fully described in U.S. patent application Ser. No. 10/134,814 filed Apr. 29, 2002 in the names of Lee Allen, Toshio Miki, and Shahid Shoaib and entitled “Context Aware Search Service,” commonly assigned to the assignee of the present application, which is incorporated herein by reference in its entirety.

In short, context-aware services are services whose operation is affected in some way by: the context of the user, external context, or the characteristics or context of the device used by the customer. Examples of the context of the user include customer identity, present activity in which the customer is engaged, physical location, schedule/agenda, and usage habits. Examples of the external context include the time of day, nearby people, or other nearby activity. Examples of the characteristics or context of the device used by the customer include computing capabilities, display capabilities, proximity to other devices with resources available for sharing, or type of network that the customer is presently using. Thus, the Hyper Operator may contain a large amount of both customer-specific and context-specific information.

The customer-specific and real-time contextual information may be used to personalize both the request and the response, for example formatting the display or whether or not to send information based on the receiver's physical location. Such customization may not be used for traditional communication devices. Additionally, the concentration of customer-specific and context-specific information at the Hyper Operator creates an opportunity to provide a service that greatly expands third-party vendors' flexibility in structuring bid-sell arrangements with groups of customers.

As noted above, a demand exists for communications technologies that permit the selling process to evolve from the relatively static publish-response model that currently exists to a more dynamic model in which buyers and sellers interact iteratively and automatically to converge on an immediate and optimal deal for each individual buyer and seller. This evolved model uses a mechanism by which a seller or sellers continuously communicate the existence and availability of a particular product, and potential buyers continuously signal their individual levels of interest in purchasing the particular product as well as their individual pricing requirements. As defined herein, products include both goods and services offered by the vendor and desired by the customer. A vendor includes any entity offering the product for sale. Thus for example, a vendor may be a company that produces and markets its own products, a company that merely distributes or sells the products, or an individual seller of the product.

The method described herein is a service that aggregates potential buyers' offers to buy a given product or service at prices specified by each potential buyer in real time, and compares the aggregated offers to a “sell-offer algorithm” created by the seller(s) in real time, in order to arrange a selling situation that is acceptable to the buyers and to the seller(s) in aggregate.

In one embodiment of the method, a customer uses a communication device to detect a sell offer (for example, by using a mobile wireless handset to detect a signal from a TV-based shopping service) and enters a maximum desirable price for a given product into the communication device. The entering of the price may signify a buy offer/bid to the Hyper Operator by automatically transmitting the price to the Hyper Operator or the customer may enter the price, review the price, and then separately transmit the price to the Hyper Operator. In the latter embodiment, this is to say that either the device or the Hyper Operator would request confirmation from the customer before final submission of the price. The customer would review the price visually or audibly, for example on a display of the device or through verbal feedback from the device, before confirming and transmitting the final buy offer to the Hyper Operator. In fact, generally the customer may receive the information and indicate the particular maximum price that her/she is willing to pay visually or audibly, although at least in the latter case preferably not while the customer is conversing with another party for example.

Thus, in one embodiment, the amount of information that the customer supplies is minimized as the only entry of information the potential buyer makes (exclusive of the above confirmation of the buy offer) is that of price prior to consummation of the sale, not quantity of goods or time of service. This is of convenience to the customer as transactions can be completed quickly and easily without the necessity of entering large amounts of other information into the communication device. Other information that could be entered includes quantities of product or other qualifications that are used to rate the satisfaction of the customer to a particular transaction in deciding whether or not to consummate the transaction. In fact, requiring entry of such information may well dissuade the customer from ordering any product, thus eliminating any potential benefit to the customer, vendor, or Hyper Operator.

Additionally, unlike previous related art, the communication device here is not required to perform difficult calculations in order to realize a transaction. This means that it is not necessary for the communication device to be a powerful computer or workstation. Furthermore, with the rapid increase in cost, as well as increase in power consumption (e.g. battery drain) and heating problems inherent with increasing computation power and processing speed, it is in fact undesirable for many communication devices, especially mobile devices, to use electronics having such large computation power.

Once the Hyper Operator has received the buy offer for a given product, the Hyper Operator then aggregates the buy offer with other buy offers received from other customers for the same product. The Hyper Operator next uses the aggregate of buy-offers to construct a buyers' function, which varies in real time as sales get consummated and new buyers enter the market. As used herein, the Hyper Operator consummates the sale using the information supplied by the buyer and seller to decide which seller is to provide the product for which buyer, and the sale is completed once the buyer and seller receive all relevant information about the transaction and react, if they must, in the necessary manner (such as providing credit card information or sending authentication, verification, or confirmation of reception of the order).

The buyers' function is continuously compared to a previously-constructed sellers' function. The sellers' function is a representation of the willingness of one or more vendors to sell the given product as a function of price. When a comparison yields a profit level that meets or exceeds a predetermined target level specified by the vendor or vendors, the sale of the product is consummated between the qualifying customer(s) and vendor(s).

In another embodiment of this method, customers create buy offers and the Hyper Operator constructs a buyers' function as before, but additionally the Hyper Operator provides the vendor the ability to sell to each potential customer at that customer's maximum agreeable price, starting with the highest price bid and continuing until a point is reached that satisfies some criterion set by the vendor. This criterion may be a maximum amount of product that the particular vendor has allotted for sale or a minimum profit margin for the particular vendor, for example.

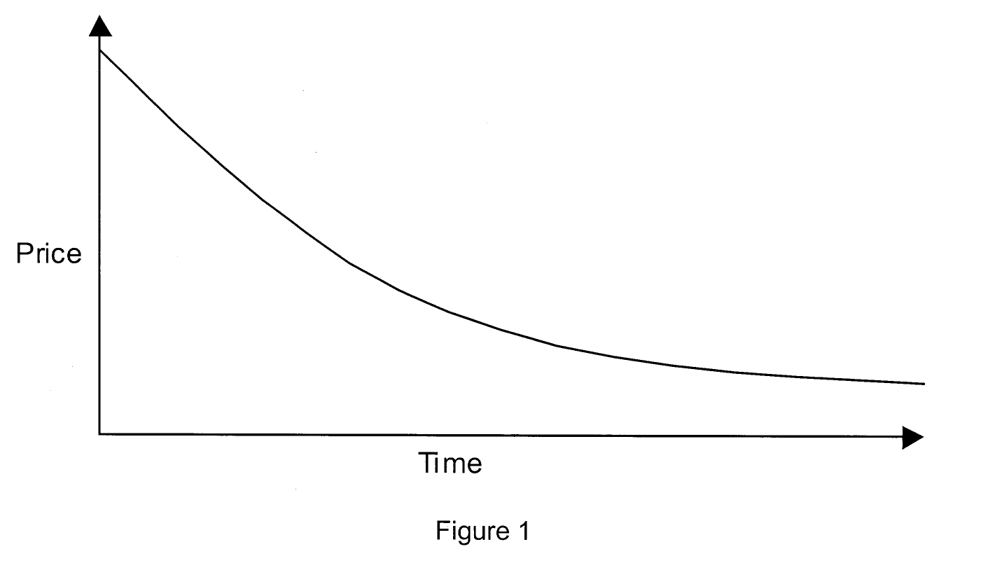

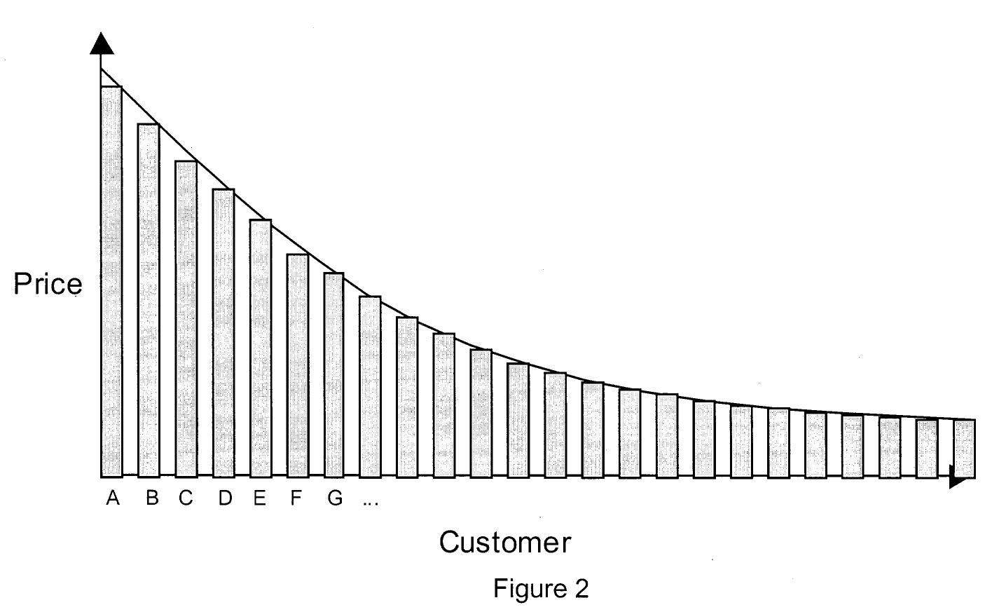

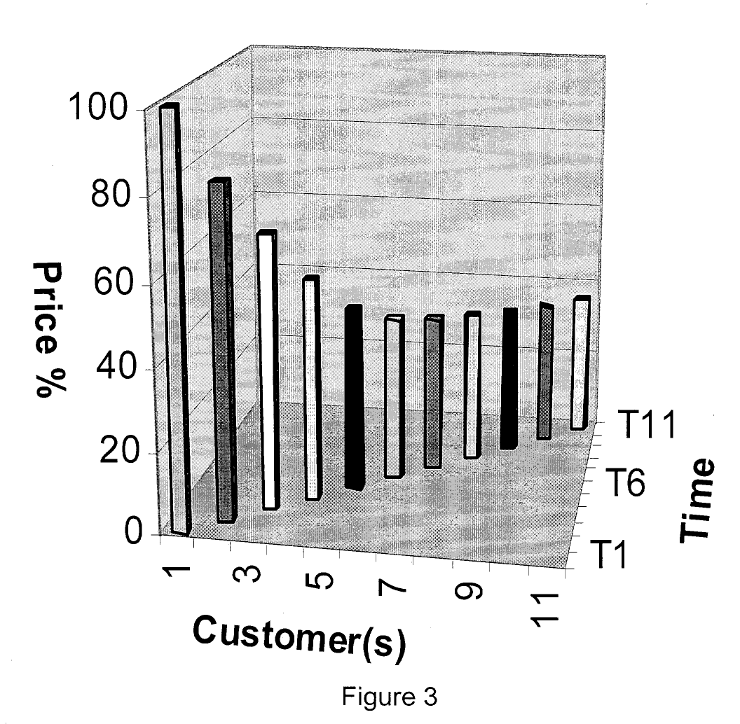

The aforementioned process has traditionally occurred over an extended period of time, as the price of the product adjusts to real-world market demand. This is shown in FIG. 1, which shows a typical price decrease with increasing time. In the traditional method, all customers buy at the same fixed price at any given moment in time, and the fixed price trends downward to capture those sellers who were unwilling to buy at earlier, higher prices as illustrated in FIG. 2. FIG. 3 is an illustration of a three dimensional plot that combines FIGS. 1 and 2. FIG. 3 shows that as time increases and the price drops (and perhaps the product becomes more popular or more well established), the number of individual buyers willing to pay that particular price increases.

The present method, however, enables sellers to time-compress the demand curve shown in FIGS. 1-3, thus permitting the vendors to collapse the traditional process into a single aggregate transaction, with sales conducted with different buyers simultaneously at different prices. Moreover, while the traditional version of this process has usually proceeded with the price adjusting downward over time, this method provides the flexibility to simulate both positive and negative price movement.

Different processes may be used to conduct a sale with different buyers simultaneously at different prices. In one embodiment, sales occur only at a specified sale consummation time, at which point the processing and sale occurs. Buy offers and sell offers are collected up to the sale consummation time and then the deals are completed at that time. This time could be specified at a particular time(s), such as 5:37 pm, or at intervals, such as every 10 minutes. In another embodiment, the sale consummation time is triggered by one or more specified conditions being satisfied. The states of these conditions may be continuously or intermittently monitored with the sale consummation time triggered by one or more different combinations of states. Another embodiment may combine the previous embodiments, that is, the sales are completed when specified conditions met or at the specific sale consummation time, whichever occurs first.

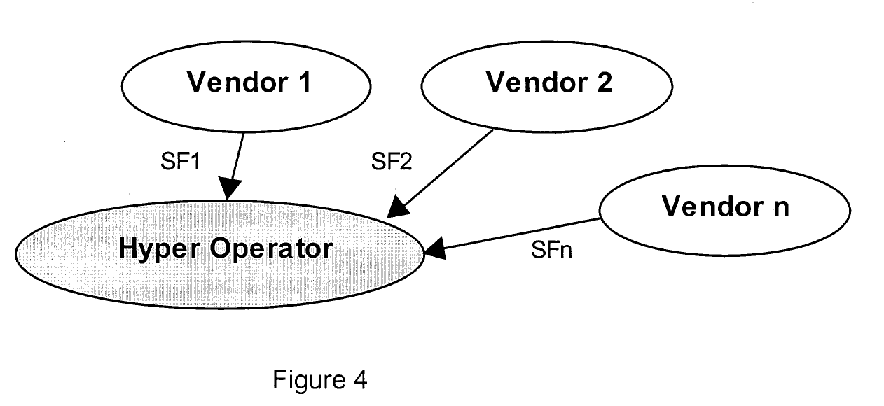

FIGS. 4-8 illustrate one embodiment of the method herein. In this embodiment, participating vendors first communicate their price points for a given product to the Hyper Operator (HO), as illustrated in FIG. 4. The term price points denotes the willingness of the vendor to sell at different prices; in different examples, the number of goods the vendor will sell at each price or the service the vendor will supply at each price. The vendors communicate this information in the form of a seller's function (SF), which the Hyper Operator receives. Of course, the vendor must update the Hyper Operator as the information changes, such as when fewer or more products become available for some reason. Note that if fewer products become available due to a sale negotiated by the Hyper Operator, either the Hyper Operator can keep track of the number of products available internally or the vendor can update the information after confirming the sale with the customer or Hyper Operator.

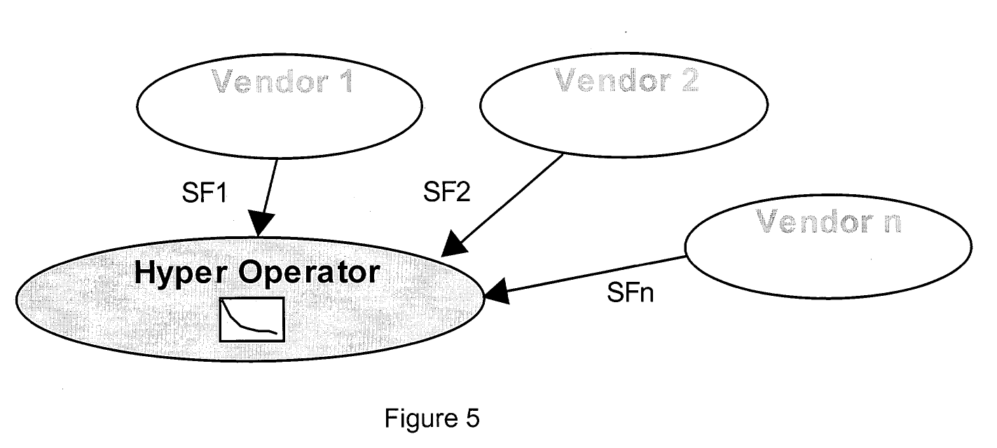

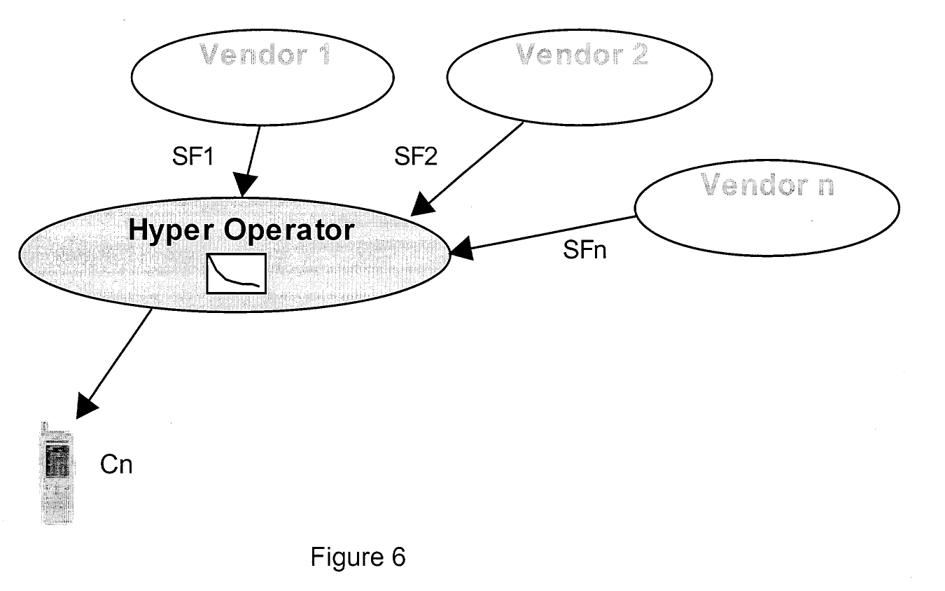

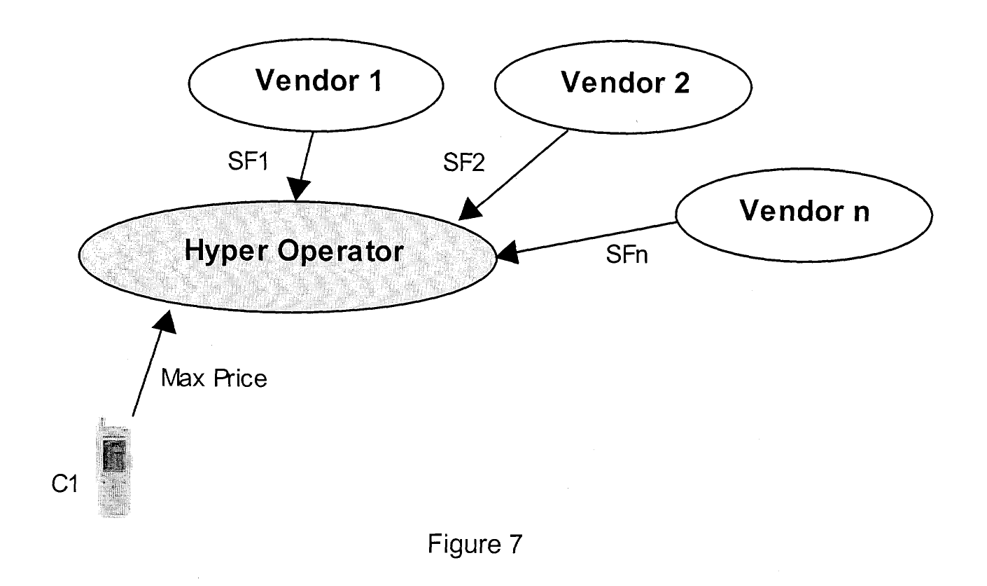

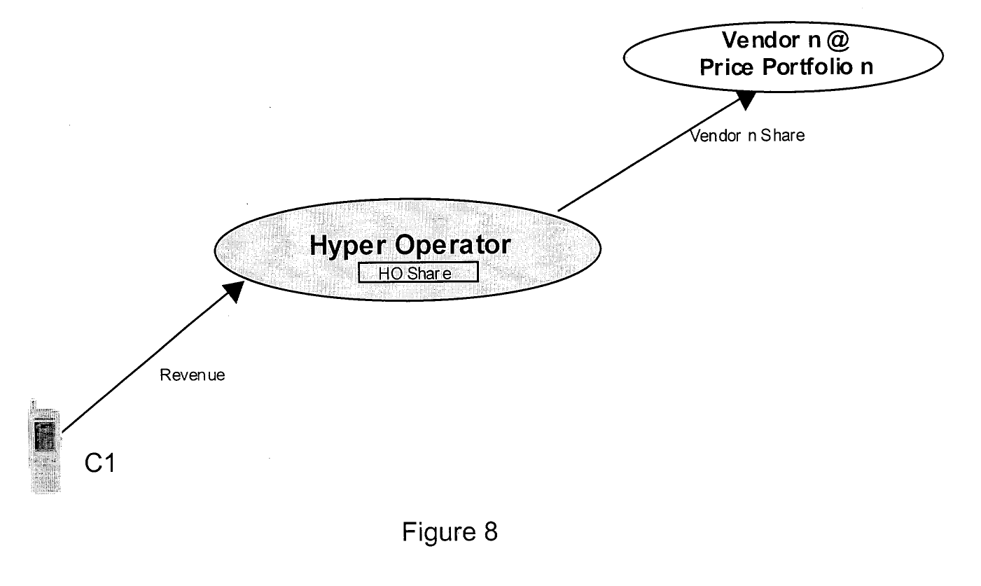

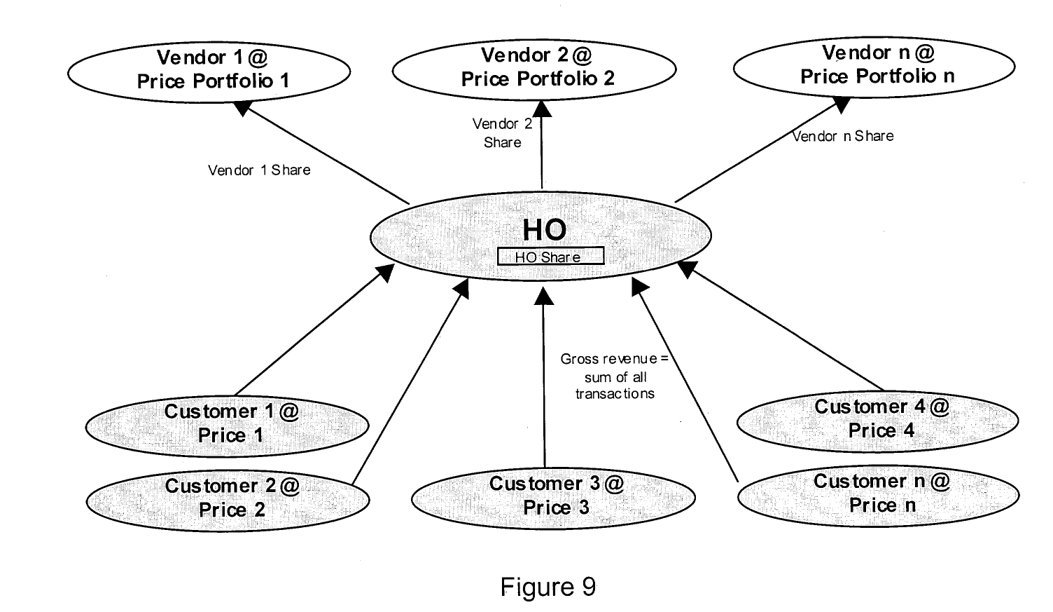

As shown in FIG. 5, the Hyper Operator integrates the vendors' functions into an aggregate sellers' function to be used in handling purchase transactions. Next, as shown in FIG. 6, the Hyper Operator presents the product to customers (Cn) of the Hyper Operator as a single offer. When a customer (C1) decides to purchase the product, the customer indicates the maximum price at which that customer is willing to buy the product and transmits this information to the Hyper Operator as illustrated in FIG. 7.

The Hyper Operator reviews the information from the customer and compares it to the aggregate seller's function. If the customer's price falls within the aggregate sellers' function, the Hyper Operator permits a sale to be completed, transmitting the necessary information to both the customer and the designated vendor to whom the transaction is to be consummated. The information supplied to the customer may include, for example, confirmation of the purchase, vendor information (e.g. name, address), amount paid, cancellation procedures for that designated vendor.

The designated vendor receives information about both the product and the customer from the Hyper Operator only after the sale has been consummated. This information about the product may include which product has been sold, the amount the product was sold for, and other relevant information. The information about the customer may include, for example, the name and address of the customer, shipping arrangements, as well as credit card or other payment information and marketing information (e.g. age, income range) for the vendor and other relevant information. This customer information may be supplied from the customer database of the Hyper Operator or from the customer him or herself, as relayed through the Hyper Operator once the sale has been consummated. For example, the Hyper Operator may maintain credit card information for one or more credit cards possessed by the customer. The customer then selects the particular credit card to be used to purchase the product after being informed of the sale. Alternately, the Hyper Operator may debit a proxy account maintained by the Hyper Operator for the customer and either charge a predetermined credit card or transmit a bill to the customer at the end of the next billing period.

The payment information may be maintained as confidential by the Hyper Operator, which may complete the transaction itself and just send a summary of the necessary information to both parties thus keeping the transaction essentially completely opaque to both parties. Of course, security of the transaction is always an issue. For example, in different embodiments, to complete the transaction the customer must enter proper identification code that the Hyper Operator or vendor recognizes. Such a unique identification code is likely to decrease possible fraud in the future as, for example, lost or stolen mobile devices may not be able to be used to send products to destinations established by the purchaser (and which are other than those established by the customer such as a home/work address) unless the purchaser can confirm the transaction and/or address change from the previously designated shipping address maintained by the Hyper Operator.

Along with this information, the designated vendor receives revenue according to that vendor's agreement with the Hyper Operator. As shown in FIG. 8, in one embodiment, the Hyper Operator receives revenue from the customer by debiting the customer's account with the Hyper Operator by the agreed amount (e.g. cost of good and shipping) or placing the agreed amount on a credit card previously established to pay for transactions between the customer and the Hyper Operator. The Hyper Operator then takes a share of the agreed amount and transmits the remaining amount to the designated vendor.

The Hyper Operator's share may be a set contract fee that is independent of the price of the product or the price the customer has agreed to pay for the product and that may be applied independent of whether any offer is made or transaction consummated or a set per-offer fee for each offer received by the Hyper Operator or per-purchase-transaction fee for each transaction consummated through the Hyper Operator. Alternatively, the Hyper Operator's share may be a variable per-offer fee or per-purchase-transaction fee. One such variable fee may be a percentage of the price agreed upon once the transaction is consummated or determined from the agreed price. In another example, the share could be a set amount that incrementally changes or continuous percentage dependent on where within the range of the vendor the agreed price falls. Alternatively, the share could be a combination of a set and variable fee. As shown in FIG. 9, with multiple customers and vendors, the revenue from the sale to the consumer may be as described above, but with the Hyper Operator determining how many of the product is sold by each vendor and calculating and transmitting the share to the vendors accordingly.

In summary, the vendor, who is the ultimate originator of the sell offer, compensates the Hyper Operator through one or more of the following fees: a contract fee, a per-offer fee or a per-purchase-transaction fee. The last two of these fees may be set or variable, dependent on the quantity and price of product sold.

Some of the advantages to buyers by use of the above method include that these customers of the Hyper Operator benefit from the ability to purchase products immediately or almost immediately and at prices agreeable to each individual buyer, without waiting an inordinate amount of time for prices to fall. This also means that the buyers avoid the risk that prices may not fall to the expected level.

Similarly, sellers can gain higher revenue and profits from their sales by selling to those customers who are willing to pay the most, at the maximum acceptable price for each customer. In effect, the vendor is selling down the demand curve substantially instantaneously. In addition, the vendor is moving his or her inventory more quickly. Also, this method helps capture sales that might-have been lost because the seller had initially set an unacceptably high price based on an incorrect (low) estimate of market demand. In such cases, the aggregate demand at a lower price may create an alternative selling proposition that is acceptable to the seller but not previously envisaged, possibly causing the seller to not sell at all. Thus, the method reduces the risk in pricing the product and promotes access to additional qualified customers (qualified by the Hyper Operator) with little risk to the vendor. The seller is also reducing or eliminating the effects of arbitrage by third parties, in which the third parties buy the vendor's products for a low price set by the low end of the market and then re-sell the product to the high end of the market in competition with the original vendor. Finally, the vendor can lock in customers early, rather than having to wait for prices to decrease, and possibly other sources to enter the market, thereby the vendor enjoys an enhanced image of perhaps being the first (or a primary) mover in the marketplace.

The Hyper Operator benefits through retaining its customer base by providing additional services as well as the best price for purchasing the product to the customer. The Hyper Operator does not have to charge additional fees to any of its customers in order to use the transaction service as the vendor pays the various fees involved. Alternatively, of course, the Hyper Operator could charge the customer a similar set of fees (but perhaps reduced) as that charged to the vendor. This is to say that customers may or may not pay a small set contract fee to have access to the transaction service, or per-offer fee or per-transaction fee.

The customers benefit by the Hyper Operator allowing buyers to purchase products at prices agreeable to each individual buyer.

However, because each customer is expected to provide a personal maximum agreeable price, it is likely that customers will “bid down” in expectation of receiving a more favorable price. Additionally, it should be expected that customers will test the aggregate sellers' function by proposing low prices and subsequently adjusting them higher if they do not fall within the sellers' function. This type of buyer behavior should be transparent to the functioning of the model, provided that the buyer behavior does not cause modification of the sellers' function. If the sellers' function is modified in response to buyer behavior, then a feedback loop is introduced into the system that causes the time-compression nature of the system to break down. This, in turn, will tend to eliminate the value of the system to the vendor.

Such behavior may be reduced or eliminated by the vendor specifying a minimum acceptable price, which may be contained in the information that the Hyper Operator transmits to the customer or may be used to eliminate untoward low bids by the customer while not permitting the customer to see the minimum price. The Hyper Operator may even implement a fee if the customer bids an unacceptably low price or bids a large number of times increasing the bid by a small amount each time.

The Multiprice Commerce Service provides functions beyond those presently included in traditional selling systems. For example, most systems present or imagined today provide a means for capturing extra revenue based on extra value perceived by high-paying customers, but these systems do not create an environment in which all extra revenue can be captured simultaneously.

In summary, the system supporting the Multiprice Commerce Service is fundamentally different from other selling systems in that it helps capture sales that might have been lost because of unacceptably high prices based on low initial market demand estimates, allows sellers to gain higher profits by selling to those customers who are willing to pay the most, at the maximum acceptable price for each customer, sells down the demand curve instantaneously, reducing or eliminating the effects of arbitrage, and saves vendors significant promotion, operational and capital expenditures.

Although embodiments of this system would use only aggregated data in the routing of advertisements, embodiments of the system must clearly show that they give the customer significant control over the customer's individual information, considering the potentially invasive perception given by the processing of customer purchase data.

The Hyper Operator also provides the software and necessary hardware to enable the Multiprice Commerce Service, as per the requirements of the particular Hyper Operator and communication system used by the customers and vendors. Implementations and embodiments of the algorithms that control the above Multiprice Commerce Service include computer readable software code. These algorithms may be implemented together or independently. Such code may be stored on a processor, a memory device or on any other computer readable storage medium. Alternatively, the software code may be encoded in a computer readable electronic or optical signal. The code may be object code or any other code describing or controlling the functionality described herein. The computer readable storage medium may be a magnetic storage disk such as a floppy disk, an optical disk such as a CD-ROM, semiconductor memory or any other physical object storing program code or associated data.

The Multiprice Commerce Service algorithms may be implemented in a Hyper Operator device as shown in FIG. 8 and indicated as reference number 100. The Hyper Operator device 100 generally includes a Hyper Operator unit 102 and may also include an interface unit 104. The Hyper Operator unit 102 includes a processor 110 coupled to a memory device 116. The memory device 116 may be any type of fixed or removable digital storage device and (if needed) a device for reading the digital storage device including, floppy disks and floppy drives, CD-ROM disks and drives, optical disks and drives, hard-drives, RAM, ROM and other such devices for storing digital information such as that of in the Hyper Operator database or any information necessary for data mining. The processor 110 may be any type of apparatus used to process digital information. The memory device 1 16 stores at least one of the Multiprice Commerce Service procedures, the proprietary and standard tools, and the databases. Upon the relevant request from the processor 110 via a processor signal 122, the memory communicates one of the procedures along with any necessary information via a memory signal 124 to the processor 110. The processor I 10 then performs the procedure.

The interface unit 104 generally includes an input device 114 and an output device 1 16. The output device 116 is any type of visual, manual, audio, electronic or electromagnetic device capable of communicating information from a processor or memory to a person or other processor or memory. Examples of display devices include, but are not limited to, monitors, speakers, liquid crystal displays, networks, buses, and interfaces. The input device 14 is any type of visual, manual, mechanical, audio, electronic, or electromagnetic device capable of communicating information from a person or processor or memory to a processor or memory. Examples of input devices include keyboards, microphones, voice recognition systems, trackballs, mice, networks, buses, and interfaces. Alternatively, the input and output devices 114 and 116, respectively, may be included in a single device such as a touch screen, computer, processor or memory coupled to the processor via a network. The information may be communicated to the memory device 116 from the input device 114 through the processor 110. Additionally, information may be communicated from the processor 110 to the display device 112.

While the invention has been described with reference to specific embodiments, the description is illustrative of the invention and not to be construed as limiting the invention. Various modifications and applications may occur to those skilled in the art without departing from the true spirit and scope of the invention as defined in the appended claims. Accordingly, this description and drawings are to be regarded in an illustrative rather than a restrictive sense.

1. A method of procuring transactions between at least one vendor and customers of a Hyper Operator that provides service to communication devices possessed by the customers, the method comprising:
the Hyper Operator constructing a sellers' function which varies in real time and is a representation of the willingness of the vendor to sell a product offered by the vendor as a function of price;
the customers detecting, on the device, a sell offer for the product, each customer then entering only a maximum price for the product into the device and transmitting the maximum price to the Hyper Operator prior to consummation of any sale to that customer to thereby signify a buy offer to the Hyper Operator;
the Hyper Operator receiving and subsequently aggregating the buy offers, constructing a buyers' function which varies in real time, continuously comparing the buyers' function to the sellers' function, and, when a comparison yields a profit level that at least meets a predetermined target level specified by the vendor, consummating a sale of the product between a qualifying customer and the vendor, all sales of the product to different customers being conducted by the Hyper Operator in a single aggregate transaction; and
the Hyper Operator notifying the qualifying customer and vendor of the sale, notification of the customer being personalized through use of customer-specific and real-time contextual information.

2. The method of claim 1, further comprising the Hyper Operator constructing the sellers' function as a representation of the willingness of different vendors to sell the product as a function of price and, when the comparison yields a profit level that at least meets a predetermined target level specified by a particular vendor, consummating a sale of the product between a qualifying customer and the particular vendor.

3. The method of claim 1, further comprising limiting sales to customers who are only buyers of consumer products.

4. The method of claim 1, further comprising submitting customer information to the vendor only after consummation of the sale.

5. A method of procuring transactions between at least one vendor and customers of a Hyper Operator that provides service to communication devices possessed by the customers, the method comprising:
the Hyper Operator constructing a sellers' function which varies in real time and is a representation of the willingness of the vendor to sell a product offered by the vendor as a function of price;
the customers detecting, on the device, a sell offer for the product, each customer then entering only a maximum price for the product into the device prior to consummation of any sale to that customer; and
the Hyper Operator receiving a buy offer from each customer and subsequently aggregating the buy offers, constructing a buyers' function which varies in real time, continuously comparing the buyers' function to the sellers' function, and, when a comparison of a particular maximum price by a particular customer yields a profit level that at least meets a predetermined target level specified by the vendor, consummating a sale of the product between the particular customer and the vendor at the particular maximum price, the sales being consummated starting with a highest maximum price bid by the customers and continuing until one of some criterion set by the vendor is reached and no customers remain with whom to consummate a sale, all sales of the product to different buyers being conducted in a single aggregate transaction.

6. The method of claim 5, further comprising each customer separately signifying the buy offer to the Hyper Operator after entering the maximum price for the product into the device.

7. The method of claim 5, further comprising the vendor setting the criterion as a maximum amount of product to be sold.

8. The method of claim 5, further comprising the Hyper Operator notifying the particular customer and vendor of the sale, notification of the customer being personalized through use of customer-specific and real-time contextual information.

9. The method of claim 5, further comprising limiting sales to customers who are only buyers of consumer products.

10. The method of claim 5, further comprising submitting customer information to the vendor only after consummation of the sale.

11. The method of claim 5, further comprising the Hyper Operator constructing the sellers' function as a representation of the willingness of different vendors to sell the product as a function of price and, when the comparison of the particular maximum price by the particular customer yields the profit level that at least meets the predetermined target level specified by a particular vendor, consummating the sale of the product between the particular customer and the particular vendor at the particular maximum price, the sales being consummated starting with the highest maximum price bid by the customers and continuing until some criterion set by the particular vendor is reached, all sales of the product to different buyers being conducted in a single aggregate transaction simultaneously.

12. The method of claim 5, further comprising selling to the customers at at least two different prices.

13. A method of providing transactions between at least one vendor and customers of a Hyper Operator that provides service to communication devices possessed by the customers, the method comprising:
customers purchasing a product of the vendor through the Hyper Operator at prices agreeable to each individual customer;
the vendor maximizing profits from sales to the customers by selling the product to customers who are willing to pay the most first and selling the product to customers who are willing to pay increasingly smaller amounts successively until some criterion set by the vendor is reached; and
the Hyper Operator conducting all sales of the product to different buyers in a single aggregate transaction and notifying purchasing customers and the vendor of the sale with notification of the purchasing customers being personalized through use of customer-specific and real-time contextual information.

14. The method of claim 13, further comprising selling to the customers at a maximum acceptable price for each customer.

15. The method of claim 13, further comprising selling to the customers at at least two different prices.

16. The method of claim 13, further comprising the vendor setting the criterion as one of a maximum amount of product to be sold and a minimum profit for each product.

17. The method of claim 13, further comprising the vendor compensating the Hyper Operator with a contract fee, a per-offer fee, and a per-purchase-transaction fee.

18. The method of claim 13, further comprising a plurality of vendors supplying the product, each vendor maximizing profits from sales to the customers by selling the product to customers who are willing to pay the most first and selling the product to customers who are willing to pay increasingly smaller amounts successively until a criterion set by the vendor is reached.

19. The method of claim 13, further comprising the customers establishing with the Hyper Operator a particular product desired and the Hyper Operator indicating when the sellers have that particular product for sale.

20. The method of claim 13, further comprising each customer entering only a maximum price for the product into the device prior to consummation of any sale to that customer.

21. The method of claim 20, further comprising each customer separately signifying the buy offer to the Hyper Operator after entering the maximum price.

22. The method of claim 13, further comprising limiting sales to customers who are only buyers of consumer products.

23. The method of claim 13, further comprising submitting customer information to the vendor only after consummation of the sale.

24. A method of procuring transactions between vendors and customers of a Hyper Operator that provides service to communication devices possessed by the customers, the method comprising:
the Hyper Operator constructing a sellers' function which varies in real time and is a representation of the willingness of each vendor to sell a product offered by the vendors as a function of price;
the customers detecting, on the device, a sell, offer for the product, each customer then entering only a maximum price for the product into the device prior to consummation of any sale to that customer; and
the Hyper Operator receiving a buy offer from each customer and subsequently aggregating the buy offers, constructing a buyers' function which varies in real time, continuously comparing the buyers' function to the sellers' function, and, when a comparison of a particular maximum price by a particular customer yields a profit level that at least meets a predetermined target level specified by a particular vendor, consummating a sale of the product between the particular customer and the particular vendor at the particular maximum price, the sales being consummated starting with a highest maximum price bid by the customers and continuing until one of criteria set by the vendors are reached and no customers remain with whom to consummate a sale, all sales of the product to different customers being conducted in a single aggregate transaction.

25. The method of claim 24, further comprising each customer separately signifying the buy offer to the Hyper Operator after entering the maximum price for the product into the device.

26. The method of claim 24, further comprising the vendors setting the criterion as a maximum amount of product to be sold.

27. The method of claim 24, further comprising the Hyper Operator notifying the particular customer and vendor of the sale, notification of the customer being personalized through use of customer-specific and real-time contextual information.

28. The method of claim 24, further comprising limiting sales to customers who are only buyers of consumer products.

29. The method of claim 24, further comprising submitting customer information of customers who purchase the product from the particular vendor to the particular vendor only after consummation of the sales.

30. The method of claim 24, further comprising selling to the customers at at least two different prices.

31. A communication network that establishes transactions between at least one vendor and customers of a Hyper Operator, the Hyper Operator providing service to communication devices possessed by the customers, the network comprising:
a first computation mechanism to compute a sellers' function which varies in real time, is constructed by the Hyper Operator, and is a representation of the willingness of the vendor to sell a product offered by the vendor as a function of price;
a second computation mechanism to compute a buyer's function which varies in real time and is constructed by the Hyper Operator, the buyer's function containing an aggregation of maximum prices that each of the customers is willing to pay for the product and have been transmitted to the Hyper Operator, the maximum price being the only information entered by each customer prior to consummation of any sale to that customer;
a comparison mechanism that continuously compares the buyers' function to the sellers' function;
a transaction mechanism that, when a comparison yields a profit level that at least meets a predetermined target level specified by the vendor, consummates a sale of the product between a qualifying customer and the vendor; and
a notification mechanism that notifies the qualifying customer and vendor of the sale as well as personalizes the notification to the qualifying customer through use of customer-specific and real-time contextual information, wherein all sales of the product to different customers are conducted by the Hyper Operator in a single aggregate transaction.

32. A computer readable storage medium storing computer readable program code for providing transactions between at least one vendor and customers of a Hyper Operator that supplies service to communication devices possessed by the customers, the computer readable program code comprising a computer code that implements:
construction of a sellers' function which varies in real time and is a representation of the willingness of the vendor to sell a product offered by the vendor as a function of price;
detection and aggregation of an offer for the product entered by each customer into the device, each offer containing only a maximum price willing to be paid by the customer;
construction of a buyers' function which varies in real time from the aggregation of maximum prices;
continuous comparison of the buyers' function to the sellers' function, and, when a comparison of a particular maximum price by a particular customer yields a profit level that at least meets a predetermined target level specified by the vendor, consummation of a sale of the product between the particular customer and the vendor at the particular maximum price; and
notification of the particular customer and vendor of the sale and personalization of the notification to the particular customer through use of customer-specific and real-time contextual information, wherein all sales of the product to different buyers are conducted in a single aggregate transaction.

33. The computer readable program code of claim 32, further comprising computer code that consummates sales starting with a highest maximum price bid by the customers and continuing until one of some criterion set by the vendor is reached and no customers remain with whom to consummate a sale.

34. The computer readable program code of claim 33, further comprising computer code that sets the criterion as one of a maximum amount of product to be sold and a minimum profit for each product.

35. The computer readable program code of claim 32, further comprising computer code that transfers a debit to the vendor and a credit to the Hyper Operator for one of a per-offer fee for each offer and a per-purchase-transaction fee for each sale.

36. The computer readable program code of claim 32, further comprising computer code that maximizes profits for the vendor from sales to the customers by consummating sales of the product to customers who are willing to pay the most first and consummating sales of the product to customers who are willing to pay increasingly smaller amounts successively until a criterion set by the vendor is reached.

37. The computer readable program code of claim 32, further comprising computer code that constructs the sellers' function as a representation of the willingness of each vendor of a plurality of vendors offering the product as a function of price.

38. The computer readable program code of claim 37, further comprising computer code that maximizes profits for each vendor from sales to the customers by consummating sales of the product to customers who are willing to pay the most first and consummating sales of the product to customers who are willing to pay increasingly smaller amounts successively until a criterion set by each vendor is reached.

39. The computer readable program code of claim 32, further comprising computer code that enables each customer to separately signify the offer after entering the maximum price for the product into the device but before aggregation of the offer.

40. The computer readable program code of claim 32, further comprising computer code that limits sales to customers who are only buyers of consumer products.

41. The computer readable program code of claim 32, further comprising computer code that submits customer information of the particular customer to the vendor only after consummation of the sale.

42. An electronic unit housing a Hyper Operator that procures transactions between vendors and customers of the Hyper Operator which provides services for a communication device possessed by the customers, the electronic unit comprising:
a transmitter/receiver through which the electronic unit communicates with external sources including vendors and the customers, the transmitter/receiver configured to transmit a sell offer for a product offered by at least one of the vendors to the customers and to receive a buy offer from each of the customers requesting the product, each buy offer containing a maximum price for the product willing to be paid by the customer who has entered that maximum price as a buy offer;
a processor that is configured to construct a sellers' function which varies in real time and is a representation of the willingness of the at least one of the vendors to sell the product as a function of price, aggregate the buy offers and construct a buyers' function which varies in real time, continuously compare the buyers' function to the sellers' function, and, when a comparison yields a profit level that at least meets a predetermined target level specified by the at least one of the vendors, consummates a sale of the product between a qualifying customer and the at least one of the vendors, in which all sales of the product to different customers are conducted in a single aggregate transaction;
a memory that is configured to amass a customer database of customer-specific and real-time contextual information of the customers, the transmitter/receiver configured to transmit notification to the qualifying customer and the at least one of the vendors of the sale in which the notification to the customer is personalized by the processor through the customer-specific and real-time contextual information; and
an interface through which internal elements of the electronic unit communicate.

43. The electronic unit of claim 42, wherein the processor is configured to construct the sellers' function as a representation of the willingness of different vendors to sell the product as a function of price and, when the comparison yields a profit level that at least meets a predetermined target level specified by a particular vendor, consummates a sale of the product between the qualifying customer and the particular vendor.

44. The electronic unit of claim 42, wherein the processor is configured to submit customer information to the vendor only after consummation of the sale.

45. The electronic unit of claim 43, wherein the processor is configured to consummate the sales starting with a highest maximum price bid by the customers and continue until one of: some criterion set by the vendor is reached and no customers remain with whom to consummate a sale, the processor is further configured to conduct all sales of the product to different buyers in a single aggregate transaction.

46. The electronic unit of claim 43, wherein the criterion is a maximum amount of the product to be sold.

47. The electronic unit of claim 43, wherein the criterion is a minimum price of the product to be sold.

48. The electronic unit of claim 42, wherein the processor is configured to limit sales to customers who are only buyers of consumer products.
